(19) United States
(12) Patent Application Publication
(10) Pub. No.: US 2010/0124075 A1
(43) Pub. Date: May 20, 2010

(54) Edge Type Back Light Module and Display Device Using the Same

(75) Inventors: Zhi-Ting Ye, Zaociao Township (TW); Kuo-Jui Huang, Dali City (TW); Zhan-Wei Qiu, Taichung County (TW); Wen-Chia Hsiao, Changhua County (TW); Wen-Hsiao Huang, Magong City (TW); Chun-Chih Huang, Niaosong Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WINTEK CORPORATION, Taichung (TW)

(21) Appl. No.: 12/620,731

(22) Filed: Nov. 18, 2009

(30) Foreign Application Priority Data
Nov. 18, 2008 (TW) 97144575

(51) Int. Cl. F21V 7/04

(52) U.S. Cl. 362/606

(57) ABSTRACT

An edge type back light module and a display device using the same are provided. The edge type back light module includes a light guide plate (LGP), a light source and a frame. The LGP has a light-receiving surface, a light-emitting surface and a light-reflecting surface opposite to the light-emitting surface. The light-emitting surface faces the display panel. The light source is adjacent to the light-receiving surface for emitting a light. The frame has a frame surface and a light guide portion. After a portion of the light contacts the light guide portion, the light guide portion disposed on the frame surface guides the portion of the light to be emitted from the light-emitting surface. A predetermined angle is contained between the outgoing direction of the portion of the light emitted from the light-emitting surface and the normal direction of the light-emitting surface.

This application claims the benefit of Taiwan application Serial No. 97144575, filed Nov. 18, 2008, the subject matter of which is incorporated herein by reference.

### BACKGROUND OF THE INVENTION

1. Field of the Invention

The invention relates in general to an edge type back light module and a display device using the same, and more particularly to an edge type back light module without reflective plate and a display device using the same.

2. Description of the Related Art

A liquid crystal display device mainly includes a display panel, an edge type back light module, a driving display unit, and a frame. The edge type back light module is located at one side of the display panel for providing a uniformed light source to the display panel of the liquid crystal display device. The light source is further divided into side type back light module and direct type back light module. Let the side type back light module be taken for example. The linear light source or the point light source is disposed on the lateral side of an optical film such as a light guide plate (LGP) or a diffusion film for increasing the uniformity and laminating efficiency of the light the LGP and the diffusion film.

Despite the efficiency of the light source is increased by the use of the optical films, light leakage from the bottom of the LGP still occurs. The efficiency of the light source will be increased further if the light leakage can be reflected back to the LGP and used again. Therefore, a reflector is normally disposed on the bottom of the frame of the edge type back light module for reflecting the light leakage back to the LGP.

However, the disposition of the reflective plate incurs extra cost, moreover, the reflective plate merely reflects the light leakage, and there is no control regarding at what angle is the light leakage emitted from the LGP.

### SUMMARY OF THE INVENTION

The invention is directed to an edge type back light module without a reflective plate. The light guide portion, disposed on the frame surface of the edge type back light module, reflects the light leakage back to the light guide plate (LGP) and further guides the light leakage to be emitted from the LGP at a predetermined angle, hence dispensing with the use of reflective plate and saving the cost relevant to the reflective plate. The frame is made from a material such that the reflection rate on the frame surface ranges from 65% to 100%, but the composition of the material is not defined here.

According to a first aspect of the present invention, an edge type back light module is provided. The edge type back light module is adjacent to a display panel of a display device. The edge type back light module includes a LGP, a light source and a frame. The LGP has a light-receiving surface, a light-emitting surface and a light-reflecting surface opposite to the light-emitting surface. The light-emitting surface faces the display panel. The light source is adjacent to the light-receiving surface of the LGP for emitting a light. The frame has a frame surface and a light guide portion. The frame surface faces the light-reflecting surface of the LGP. The light guide portion is disposed on the frame surface. After a portion of the light contacts the light guide portion, the light guide portion guides the portion of the light to be emitted from the light-emitting surface.

According to a second aspect of the present invention, a display device is provided. The display device includes a display panel and aforementioned edge type back light module.

The invention will become apparent from the following detailed description of the preferred but non-limiting embodiments. The following description is made with reference to the accompanying drawings.

### BRIEF DESCRIPTION OF THE DRAWINGS

FIG. 1 shows a display device according to a first embodiment of the invention;

FIG. 2 shows a part of enlarged light guide portion of FIG. 1;

FIG. 3 shows a light guide portion of FIG. 2 being a recess;

FIG. 4 shows a first implementation of a light guide portion of FIG. 2;

FIG. 5 shows a light guide portion of FIG. 4 being a recess;

FIGS. 6A and 6B show a second implementation of a light guide portion of FIG. 2;

FIG. 7A shows an extension path of a light guide portion of an embodiment of the invention;

FIG. 7B shows another implementation of an extension path of a light guide portion of FIG. 7A;

FIGS. 8A and 8B show another implementation of the frame of FIG. 1;

FIGS. 8C and 8D show another implementation of the frame of FIG. 8A to 8B;

FIG. 9 shows a display device according to a second embodiment of the invention; and

FIG. 10 shows a display device according to a third embodiment of the invention.

### DETAILED DESCRIPTION OF THE INVENTION

Two embodiments are disclosed below as exemplifications of the invention. However, the two embodiments are for exemplification only, not for limiting the scope of protection of the invention. Besides, secondary embodiments are omitted for highlighting the technical features of the invention.

### First Embodiment

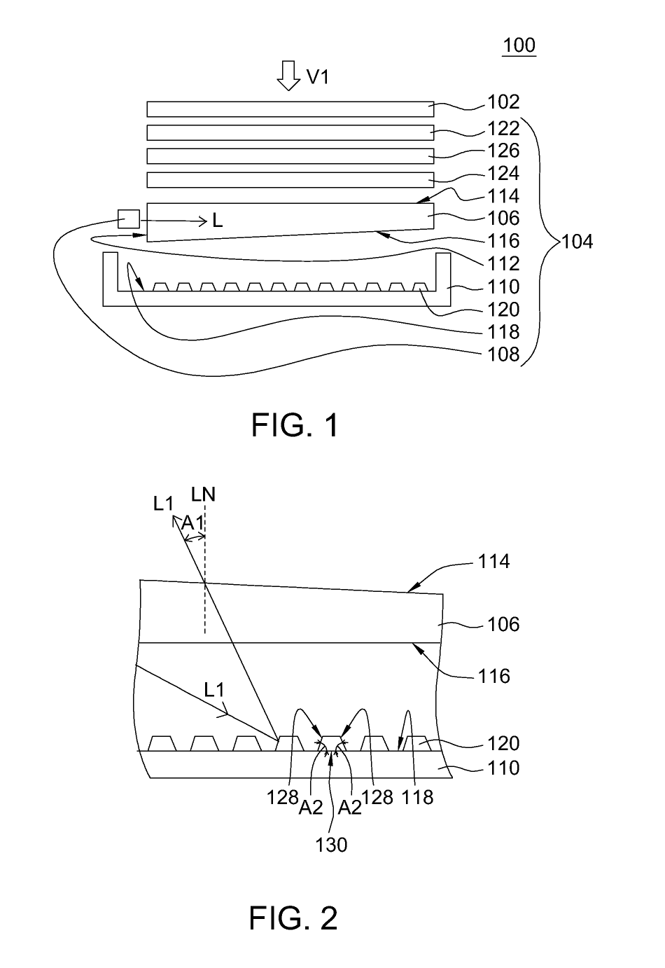

Referring to FIG. 1, a display device according to a first embodiment of the invention is shown. The display device 100 includes a display panel 102 (LCD, EPD, EWD . . . ) and an edge type back light module 104, which is adjacent to the display panel 102. The edge type back light module 104 includes a LGP 106, a light source 108, a frame 110, a first brightness enhancement film (BEF) 122, a diffusion film 124 and a second BEF 126.

The diffusion film 124 is located between the LGP 106 and the second BEF 126. The second BEF 126 is located between the first BEF 122 and the diffusion film 124. The first BEF 122, the second BEF 126 and the diffusion film 124 are adjacent to the light-emitting surface 114 of the LGP 106.

The LGP 106 has a light-receiving surface 112, a light-emitting surface 114 and a light-reflecting surface 116 opposite to the light-emitting surface 114. The light source 108 is adjacent to the light-receiving surface 112 of the LGP 106 for emitting a light L. The light-emitting surface 114 faces the display panel 102. The frame 110 has a frame surface 118 and a light guide portion 120. The frame surface 118 faces the light-reflecting surface 116 of the LGP 120.

Referring to FIG. 2, a part of enlarged light guide portion 120 of FIG.

1 is shown. The light guide portion 120 is disposed on the frame surface 118 and projected from the frame surface 118. The light guide portion 120 is used for guiding the light leakage L1 to be emitted from the light-emitting surface 114 after a portion of the light L, such as the light leakage L1 of the LGP 106, contacts the light guide portion 120. A predetermined angle A1 is contained between the outgoing direction of the light leakage L1 emitted from the light-emitting surface and the normal line LN of the light-emitting surface 114. When the predetermined angle A1 is preferably controlled to be within the range of 35 to 65 degrees, the light leakage L1 pass through the diffusion film 124, the second BEF 126, and the first BEF 122 sequentially and then L1 can be eventually emitted towards the display panel 102 in a direction perpendicular to the first BEF 122. Thus, the display luminance is the brightest, and the display quality is the best. Preferably, the light leakage L1 is the peak of the light leakage of the LGP 106.

As indicated in FIG. 2, the cross-section of the light guide portion 120 is a trapezoid, wherein the angle A2 contained between the lateral side 128 of the trapezoid and the bottom side 130 of the trapezoid ranges from 5 to 90 degree.

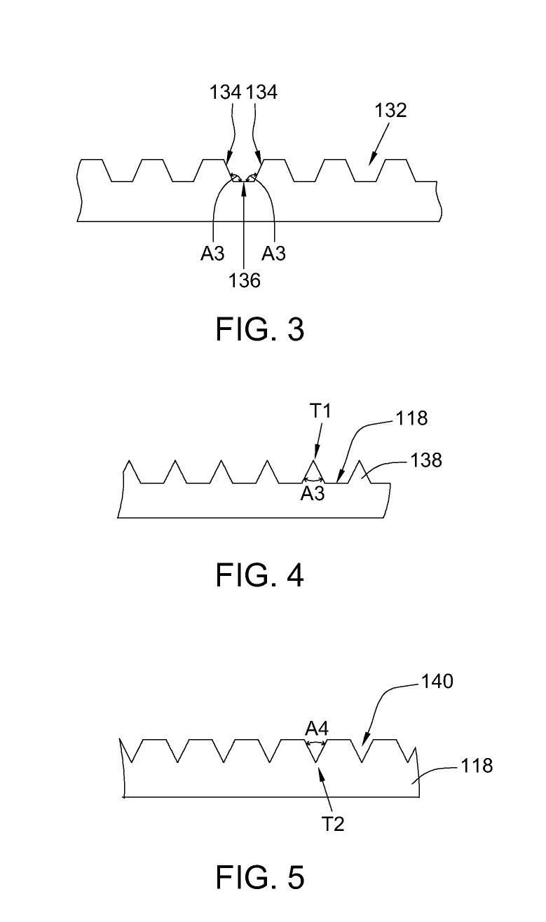

In the present embodiment of the invention, the light guide portion 120 is projected from the frame surface 118. However, in other embodiments, the light guide portion 120 can be a recess. Referring to FIG. 3, a cross-section of the light guide portion 132 is a trapezoidal recess. The angle A3 contained between the lateral side 134 of the trapezoid and the bottom side 136 of the trapezoid ranges from 90 to 175 degrees.

By use of the light guide portion 120, the light leakage L1 is reflected back to the LGP 106 so as to increase the efficiency of the light source. Moreover, the light guide portion 120 also guides the light leakage L1 to be emitted from the LGP 106 at a predetermined angle A1. Apart from saving the use of the reflective plate in conventional display module, the light guide portion of the invention further meets optical requirements.

Referring to FIG. 4, a first implementation of a light guide portion of FIG. 2 is shown. The light guide portion 138 is a protrusion projected from the frame surface 118, wherein the cross-section of the light guide portion 138 is a triangle. The vertex angle A3 of an apex T1 of the triangle ranges from 30 to 175 degrees. The apex T1 faces the light-reflecting surface 116.

Referring to FIG. 5, a light guide portion of FIG. 4 being a recess is shown. The cross-section of the light guide portion 140 is a triangular recess. The vertex angle A4 of an apex T2 of the triangle ranges from 30 to 175 degrees. The apex A4 faces the direction away from the light-reflecting surface 116 (illustrated in FIG. 2).

Thus, the light guide portions 138 and 140 with a triangular cross-section control the predetermined angle A1 to be within the range of 35 to 65 degrees, so that the light leakage L1, after being emitted towards the diffusion film 124, is emitted from the first BEF 122 in a direction perpendicular to the first BEF 122. Due to the manufacturing factors, the vertex angle T1 of the light guide portion 138 and the vertex angle T2 of the light guide portion 140 may be in the shape of a circular arc, not a sharp angle. Nevertheless, the function of the light guide portion of the invention is not affected.

In the present embodiment of the invention, the cross-section of the light guide portion is exemplified by a triangle or a trapezoid. However, in other embodiments, the cross-section of the light guide portion can be a polygon (not illustrated).

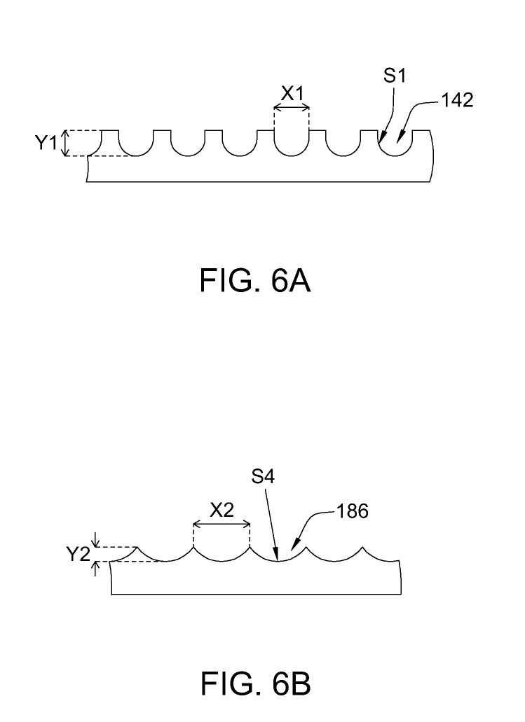

Referring to FIGS. 6A and 6B, a second implementation of a light guide portion of FIG. 2 is shown. In FIGS. 6A and 6B, the light guide portion is exemplified by a recess. However, the light guide portion 142 can be a protrusion projected from the frame surface 118. As indicated in FIG. 6A, the cross-sectional silhouette S1 of the light guide portion 142 is a curve, which can be a portion of a circular curve, such as an arc curve in which the ratio of width X1 to height Y1 ranges from 0.1 to 10. Or, in another implementation, the curve can be a portion of an elliptical curve (not illustrated), in which the ratio of width X1 to height Y1 also ranges from 0.1 to 10. Or, as indicated in FIG. 6B, the light guide portions 186 are interconnected and the cross-sectional silhouette S4 of the light guide portions 186 is a curve, which can be a portion of a circular curve, such as a circular curve in which the ratio of width X2 to height Y2 also ranges from 0.1 to 10. Or, in another implementation, the curve can be a portion of an elliptical curve (not illustrated), in which the ratio of width X2 to height Y2 also ranges from 0.1 to 10.

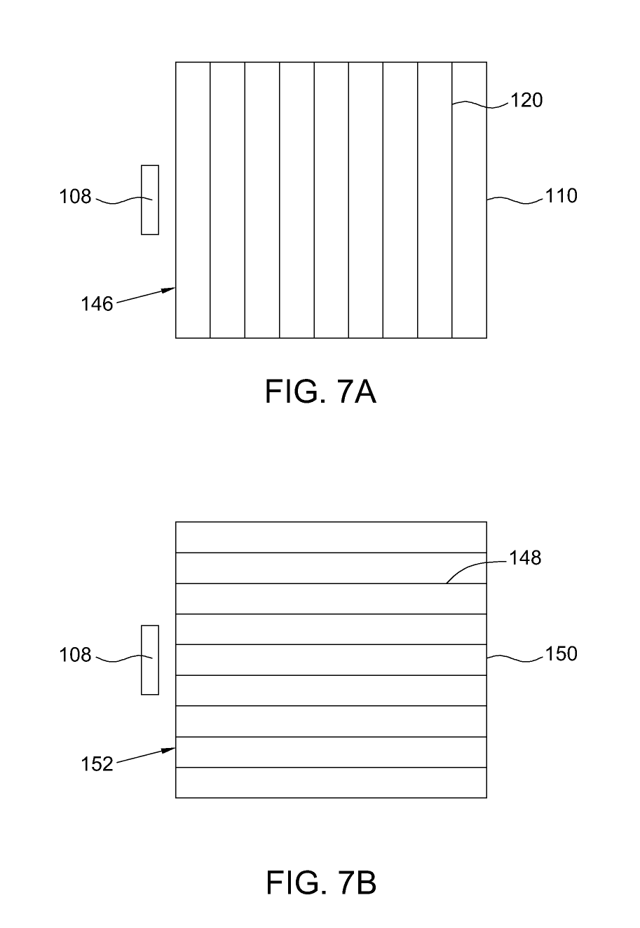

FIG. 7A shows the frame 110 viewed along the direction V1 of FIG. 1. In FIGS. 7A and 7B, the extension path of the light guide portion 120 is a straight line substantially parallel to or perpendicular to one side 146 of the LGP 106. Referring to FIG. 7A, the extension path of the light guide portion is parallel to one side 146 of the frame 110. Referring to FIG. 7B, the light guide portion 148 is a straight line, and the extension path of the light guide portion 148 is substantially perpendicular to one side 152 of the frame 150. Alternatively, the extension path of the light guide portion does not have to be a straight line. The light guide portion can be an arc or a wave-shaped (not shown in FIG). In other embodiments, the extension path of the light guide portion can be continuous in particular segments only, and is not limited to the exemplification in the present embodiment of the invention.

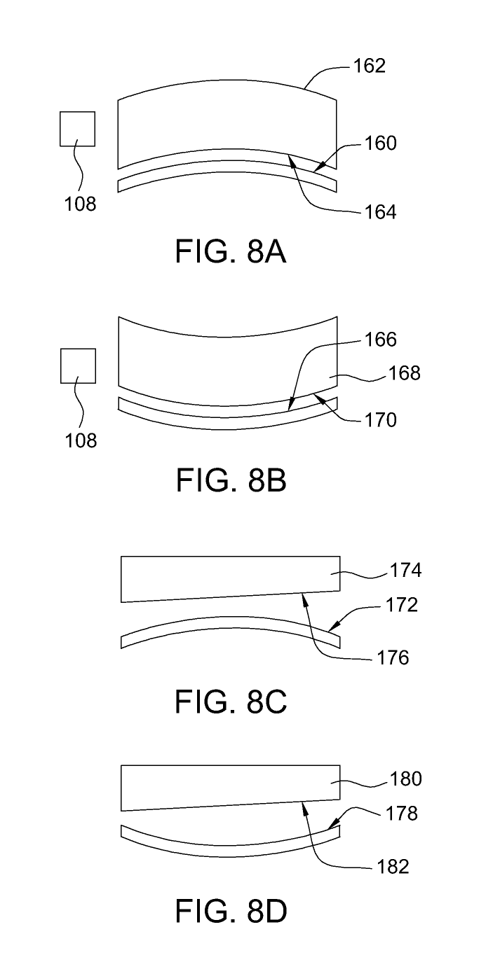

In the present embodiment of the invention, the frame surface 118 is exemplified by a plane. However, in other embodiments, the curvature of the frame surface 118 corresponds to the curvature of the LGP 106. Referring to FIGS. 8A and 8B, another implementation of the frame of FIG. 1 is shown. As indicated in FIG. 8A, the frame surface 160 and a surface 164 of the LGP 162 are both a curved surface, the silhouette of the curved surface of the frame surface 160 corresponds to the silhouette of the surface 164 of the LGP 162. As indicated in FIG. 8B, the frame surface 166 and a surface 170 of the LGP 168 are both a curved surface, and the silhouette of the curved surface of the frame surface 166 corresponds to the silhouette of the surface 170 of the LGP 168. Referring to FIGS. 8C and 8D, another implementation of the frame of FIGS. 8A to 8B is shown. As indicated in FIG. 8C, the frame surface 172 is a curved surface, and a surface 176 of the LGP 174 is a plane. As indicated in FIG. 8D, the frame surface 178 is a curved surface, and a surface 182 of the LGP 180 is a plane. The curvature on the appearance of the frame surface 172 of FIG. 8C differs with that of the frame surface 178 of FIG. 8D.

### Second Embodiment

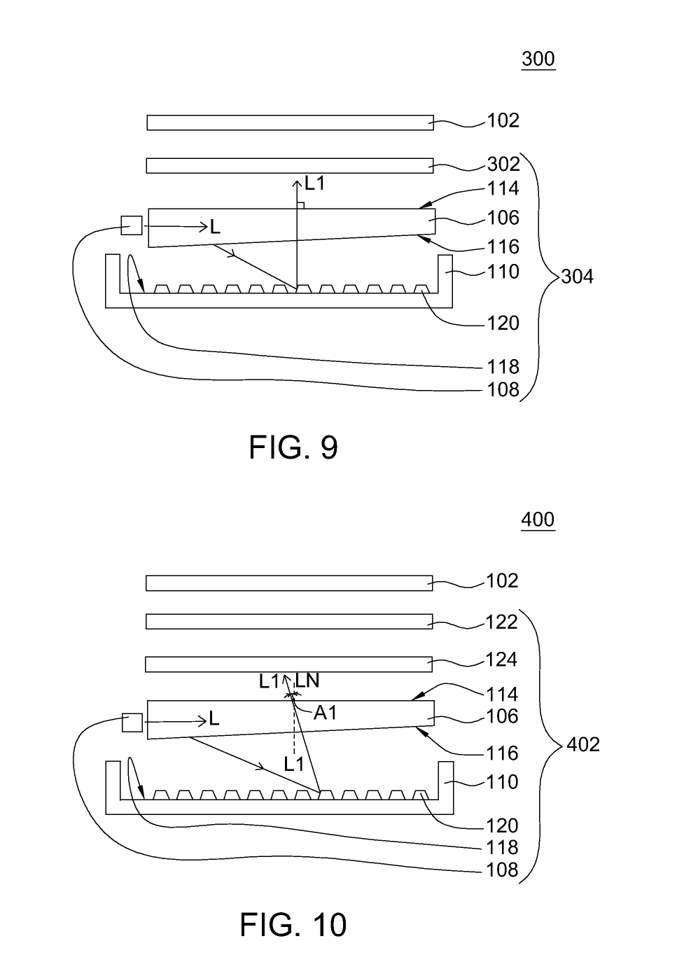

Referring to FIG. 9, a display device according to a second embodiment of the invention is shown. The second embodiment differs with the first embodiment in that, the edge type back light module 304 of the second embodiment partly or completely replaces the first BEF 122, the diffusion film 124 and the second BEF 126 of the first embodiment with a dual brightness enhancement film (DBEF) 302, which is adjacent to the light-emitting surface 114 of the LGP 106. Referring to FIG. 1, the first BEF 122 can be replaced by a multi-functioned brightness enhancement film (not illustrated) such as a brightness enhancement film-reflective polarizer (BEF-RP). As for other similarities, the same designations are used and are not repeated here.

When the DBEF 302 is used, if the predetermined angle A1 is preferably controlled at 0 degree, the light leakage L1 can be emitted from the DBEF 302 in a direction perpendicular to the DBEF 302 and emitted towards the display panel 102. Thus, the display has the brightest luminance. When the BEF-RP (not illustrated) is used and the light guide portion has suitable design, the predetermined angle of the light emitted from the light-emitting surface of the LGP is preferably controlled to be within the range of 35 to 65 degrees, the display luminance has the brightest luminance. The predetermined angle of the light emitted from the light-emitting surface refers to the peak of the light intensity.

After the light leakage L1 (illustrated in FIG. 2) contacts the light guide portions such as the light guide portion 120, 132, 138, 140, 142, 148, or 186, the light guide portion guides the light leakage L1 to be emitted from the light-emitting surface 114. The outgoing direction of the light leakage L1 emitted from the light-emitting surface 114 is perpendicular to the light-emitting surface, so that the light leakage L1 is emitted from the first BEF 122 in a direction perpendicular to the first BEF 122 and emitted towards the display panel 102.

### Third Embodiment

Referring to FIG. 10, a display device according to a third embodiment of the invention is shown. The third embodiment differs with the first embodiment in that, the edge type back light module 402 of the third embodiment dispenses with one of the first BEF 122 and the second BEF 126 of the first embodiment. In the present embodiment of the invention, the second BEF 126 is dispensed with for exemplification. As for other similarities, the same designations are used and are not repeated here.

When the first BEF 122 is combined with the diffusion film 124, if the predetermined angle A1 of the light emitted from the light-emitting surface 114 is controlled to be within the range of 15 to 45 degrees, the light leakage L1 is emitted from the first BEF 122 in a direction perpendicular to the BEF 122 and emitted towards the display panel 102. Thus, the display has the brightest luminance. The predetermined angle A1 of the light emitted from the light-emitting surface 114 refers to the peak of the light intensity.

After the light leakage L1 contacts the light guide portion such as the light guide portion 120, 132, 138, 140, 142, 148, or 186, the light guide portion guides the light leakage L1 to be emitted from the light-emitting surface 114. The angle contained between the outgoing direction of the light leakage L1 emitted from the light-emitting surface 114 and the normal direction of the light-emitting surface LN ranges from 15 to 45 degrees, so that the light leakage L1 is emitted from the first BEF 122 in a direction perpendicular to the first BEF 122 and emitted towards the display panel 102.

The edge type back light module and the display device using the same disclosed in the above embodiments of the invention have many advantages exemplified below:

(1) Compared with the conventional frame, the frame of the present embodiment of the invention dispenses with the use of the reflective plate, hence saving the cost relevant to the reflective plate, such as the material cost, the design cost, and the cost of manufacturing and adhering the reflective plate.

(2) The light guide portion not only reflects the light leakage back to the LGP but also guides the light leakage to be emitted from the LGP at a predetermined angle, further meeting the optical requirement of the optical film.

(3) The light guide portion of the present embodiment of the invention is not subject to the number of the optical film. The light guide portion of the invention still meets the optical requirements regardless how many BEFs or diffusion films are used in the first embodiment, the second embodiment and the third embodiment.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An edge type back light module adjacent to a display panel of a display device, wherein the edge type back light module comprises:
a light guide plate (LGP) having a light-receiving surface, a light-emitting surface and a light-reflecting surface opposite to the light-emitting surface, wherein the light-emitting surface faces the display panel;
a light source adjacent to the light-receiving surface for emitting the light to enter the LGP; and
a frame having a frame surface and a plurality of light guide portions, wherein the frame surface faces the light-reflecting surface of the LGP, the light guide portions are disposed on the frame surface, so that after the light leaked from the light-reflecting surface contacts the light guide portions, the light leakage is guided to enter the LGP again;
wherein, the frame is made from a material whose reflection rate of the light ranges from 65% to 100%, and a predetermined angle is contained between the outgoing direction of the light emitted from the light-emitting surface and a normal direction of the light-emitting surface.

2. The edge type back light module according to claim 1, wherein the cross-section of each light guide portion is a triangle.

3. The edge type back light module according to claim 2, wherein each light guide portion is projected from the frame surface, and the vertex angle of an apex of the triangle ranges from 30 to 175 degrees.

4. The edge type back light module according to claim 2, wherein each light guide portion is a recess, the vertex angle of an apex of the triangle ranges form 30 to 175 degrees, the apex faces the direction away from the light-reflecting surface of the light guide plate.

5. The edge type back light module according to claim 1, wherein the cross-section of each light guide portion is a trapezoid.

6. The edge type back light module according to claim 5, wherein each light guide portion is projected from the frame surface, and the angle contained between a lateral side of the trapezoid and the bottom side of the trapezoid ranges from 5 to 90 degrees.

7. The edge type back light module according to claim 5, wherein each light guide portion is a recess, and the angle contained between a lateral side of the trapezoid and the bottom side of the trapezoid ranges from 90 to 175 degrees.

8. The edge type back light module according to claim 1, wherein the cross-section of each light guide portion is a polygon.

9. The edge type back light module according to claim 1, wherein a portion of the cross-sectional silhouette of each light guide portion is a curve, the curve is a portion of an elliptical curve, and the ratio of width to height of the elliptical curve ranges from 0.1 to 10.

10. The edge type back light module according to claim 1, wherein a portion of the cross-sectional silhouette of each light guide portion is a curve, the curve is a portion of a circular curve, and the ratio of width to height ranges from 0.1 to 10.

11. The edge type back light module according to claim 1, wherein the frame surface is a curved surface.

12. The edge type back light module according to claim 11, wherein the light-reflecting surface of the LGP is a curved surface.

13. The edge type back light module according to claim 1, wherein the extension path of each light guide portion is a straight line.

14. A display device having a display panel and the edge type back light module according to claim 1, wherein the edge type back light module is disposed adjacent to the display panel.

15. The display device according to claim 14, wherein the cross-section of each light guide portion is a triangle, and a vertex angle of the triangle ranges from 30 to 175 degrees.

16. The display device according to claim 14, further comprises:
a dual brightness enhancement film (DBEF) disposed adjacent to the light-emitting surface of the LGP;
wherein, the predetermined angle is 0 degree.

17. The display device according to claim 14, wherein the predetermined angle ranges from 35 to 65 degrees inclusive of 35 and 65 degrees.

18. The display device according to claim 17, further comprises:
a first brightness enhancement film (BEF) disposed adjacent to the light-emitting surface of the LGP; and
a diffusion film located between the LGP and the first BEF;
wherein, the predetermined angle ranges from 15 to 45 degrees.

19. The display device according to claim 18, further comprising a second BEF located between the first BEF and the diffusion film.

20. The display device according to claim 18, further comprising a brightness enhancement film-reflective polarizer (BEF-RP) located between the display panel and the diffusion film.
